(19) United States
(12) Patent Application Publication
(10) Pub. No.: US 2025/0292177 A1
(43) Pub. Date: Sep. 18, 2025

(54) AUTOMATED POLICY MANAGEMENT

(71) Applicant: Wells Fargo Bank, N.A., San Francisco, CA (US)

(72) Inventor: Preeti Santhanam Iyer, Gilbert, AZ (US)

(21) Appl. No.: 18/604,168

(22) Filed: Mar. 13, 2024

(51) Int. Cl. G06Q 10/0637; G06F 8/30

(52) U.S. Cl. CPC G06Q 10/0637; G06F 8/31

(57) ABSTRACT

An example computer system for automating policy management can include: one or more processors; and non-transitory computer-readable storage media encoding instructions which, when executed by the one or more processors, causes the computer system to create: a translation engine programmed to take policy code in a first format and translate the policy code to a second format; and a pipeline engine programmed to automatically distribute the policy code in the first format to a first policy engine and distribute the policy code in the second format to a second policy engine.

### BACKGROUND

An organization can be governed by hundreds or thousands of different policies. Typically, each of these policies must be addressed separately. This involves the expression of each policy in different proprietary formats that are fed to various policy engines. This process requires steep learning curves for each of the proprietary formats and is labor-intensive when releasing policies that impact multiple different systems within the organization.

### SUMMARY

Examples provided herein are directed to the automated management of policies.

According to one aspect, an example computer system for automating policy management can include: one or more processors; and non-transitory computer-readable storage media encoding instructions which, when executed by the one or more processors, causes the computer system to create: a translation engine programmed to take policy code in a first format and translate the policy code to a second format; and a pipeline engine programmed to automatically distribute the policy code in the first format to a first policy engine and distribute the policy code in the second format to a second policy engine.

According to another aspect, an example method for automating policy management can include: translating policy code in a first format to a second format; and automatically distributing the policy code in the first format to a first policy engine and distribute the policy code in the second format to a second policy engine.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system for the automated management of policies.

FIG. 2 shows example logical components of a server device of the system of FIG. 1.

FIG. 3 shows example physical components of the server device of FIG. 2.

### DETAILED DESCRIPTION

This disclosure relates to the automated management of policies.

In example embodiments, various policies can govern an organization. These policies can number in the hundreds or thousands. Examples of such policies include, without limitation, security policies that govern how computer assets can be used within the organization. Examples of such policies include, without limitation, policies governing the downloading of software from outside of the organization. This is one example of the many hundreds or thousands of policies that can govern the organization.

In these examples, the concept can include a policy pipeline that provides checks and balances to assure policies are standardized before they are pushed out to the endpoints. This, in combination with an example translator, allow for the automation of policy generation and distribution.

More specifically, in the examples provided herein, a policy translator can be programmed to convert policies between multiple proprietary policy formats and then use pipelines to deploy them to appropriate policy engines. This unique combination of a policy translator and pipeline technology permits a user with expertise in a single policy format to write a policy once (in the format of choice) and deploy it anywhere in an environment containing multiple policy engines that operate on multiple policy formats.

This concept can be valuable for scaling purposes in large, regulated industries (such as the financial industry) where multiple policy enforcement engines operate. It enables lifecycle management of policies at scale across disparate tools, formats, domains, and policy engines. Organizations can hire personnel with a competency in any policy format regardless of which (and how many) different policy engines are in the environment. Additional benefits include transparency, requirements traceability, common understanding, automation, and effective governance.

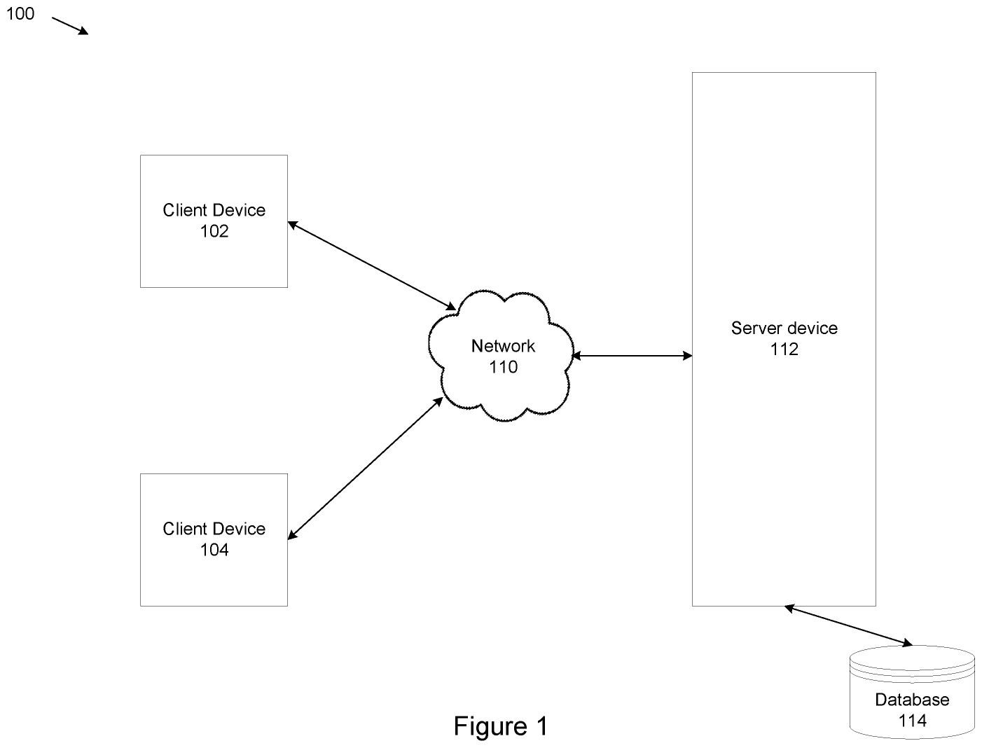

FIG. 1 schematically shows aspects of one example system 100 programmed to automate the management of policies. In this example, the system 100 can be a computing environment that includes a plurality of client and server devices. In this instance, the system 100 includes client devices 102, 104, a server device 112, and a database 114. The client devices 102, 104 can communicate with the server device 112 through a network 110 to accomplish the functionality described herein.

Each of the devices may be implemented as one or more computing devices with at least one processor and memory. Example computing devices include a mobile computer, a desktop computer, a server computer, or other computing device or devices such as a server farm or cloud computing used to generate or receive data.

In some non-limiting examples, the server device 112 is owned by a financial institution, such as a bank. The client devices 102, 104 can be programmed to communicate with the server device 112 to identify, develop, and distribute policies for the financial institution. Many other configurations are possible.

More specifically, the example client devices 102, 104 are programmed to be used by members of the organization to develop and disseminate policies for the organization. In one example, the client device 102 can be programmed to allow for a policy to be implemented within the system 100. This can include the client device 102 identifying and/or defining the policy and transmitting the policy to the server device 112.

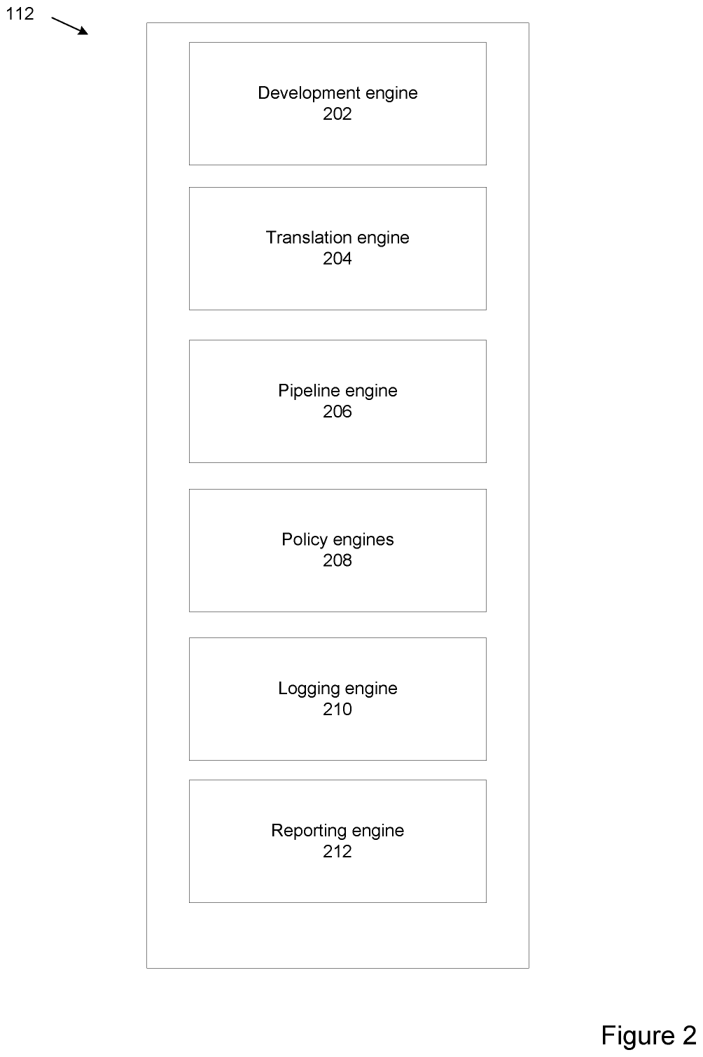

The example server device 112 is programmed to manage the policies of the system 100. In this example, this can include receiving one or more policies from the client devices 102, 104, translating those policies as necessary, storing the policies in the database 114, and disseminating those policies throughout the system 100. Additional details on the server device 112 are provided below. See FIG. 2.

The example database 114 is programmed to store the policies. In this example, the database 114 can be programmed to store data in various typical ways, such as in hierarchical, relational, and/or object oriented structures.

The network 110 provides a wired and/or wireless connection between the client devices 102, 104 and the server device 112. In some examples, the network 110 can be a local area network, a wide area network, the Internet, or a mixture thereof. Many different communication protocols can be used. Although only a few devices are shown, the system 100 can accommodate hundreds, thousands, or more of computing devices.

Referring now to FIG. 2, additional details of the server device 112 are shown. The example server device 112 can be programmed allow for the conversion of a policy from natural language into code (in a policy format of choice). The server device 112 can also act as a universal translator that converts a policy into proprietary policy formats, such as by accepting input in one policy format, perform conversions, and output policy code in multiple formats. Further, the server device 112 can be programmed to send different policy format outputs to different policy pipelines that deploy to appropriate (different) policy engines. In one example, the server device 112 can be incorporated as part of a DevOps ecosystem of the system 100, thereby allowing for faster and more efficient integration and deployment of polices within the organization.

In this example, the server device 112 has various logical modules that assist in the automation of the management of policies. The server device 112 can, in this instance, include a development engine 202, a translation engine 204, a pipeline engine 206, policy engines 208, a logging engine 210, and a reporting engine 212. In other examples, more or fewer engines providing different functionality can be used.

The example development engine 202 is programmed to accept a policy definition from the client device 102 and store that policy definition in the database 114. For instance, in one example, a developer can use the client device 102 to accept a policy and provide a policy definition for the policy. The policy definition can include policy code that represents the various components of the policy definition.

In one example, the policy definition can be defined in one format, such as a natural language format. One such natural language format is an Excel spreadsheet. The developer can use the client device 102 to define the policy in the Excel spreadsheet and communicate that spreadsheet to the development engine 202 of the server device 112. The development engine 202 stores that policy definition in the database 114.

For instance, assume a policy that is promulgated by the Federal Deposit Insurance Corporate (FDIC) that defines the liquidity requirements for a financial institution. The developer can access that policy and create a policy definition in an Excel spreadsheet on the client device 102 that quantifies the policy.

In one nonlimiting example, that policy can include limitations on where downloads for the system 100 can be performed. In this instance, the downloads can be limited to a particular domain (e.g., “*.company.net). The developer can define that requirement within the Excel spreadsheet using the following policy code.

| Requirement | Value |
|---|---|
| Limit downloads from | Only *. company.net sources are |
| specified sources | allowed. |

That requirement (along with any other requirements associated with the policy) are stored in the Excel spreadsheet, which is then communicated by the client device 102 to the development engine 202.

The example translation engine 204 is programmed to accept policy code in one of multiple (pre-configured) policy formats and output policy code in many (pre-configured) policy formats. The translation engine 204 can thereupon send outputs to appropriate policy pipelines.

In some examples, the translation engine 204 includes a model that defines translations for one language into one or more second languages. The translation engine 204 can use a set of models to provide translation services for many different types of languages. The models can be predefined and/or created using artificial intelligence that is trained to accept policy code in one language and translate that policy code into a plurality of second policy languages. In one example, there is a model that is defined for each translation from one policy language to another policy language. In other examples, different configurations for the models can be used.

More specifically, the translation engine 204 is programmed to take a policy defined in natural language and convert that definition to different languages/formats for multiple policy engines. For instance, the translation engine 204 can accept a policy definition in a first language (e.g., Sentinel Language Specification), and translate that definition to a second language (e.g., Rego). To do so, the translation engine 204 is programmed to use a model that accepts a policy code defined in Sentinel Language Specification and output that policy code in Rego (and/or a plurality of other policy codes).

For instance, the translation engine 204 can be programmed to take the policy code defined above and translate the policy code into a second policy language. In this example, the second policy language can look like the following.
Exclude download from sources≠*.company.net

This is a simple example of such a translation by the translation engine 204. In other examples, the policy definitions can include hundreds or thousands or more of code that is translated by the translation engine 204. Many different languages can be accommodated by the translation engine 204, such as (without limitation) Sentinel Language Specification, Rego, Python, and configuration languages like JSON, YAML, and/or XML.

In some examples, the translation engine 204 is programmed to identify the type(s) of each of the policy engines. Based upon the types, the translation engine 204 determines which policy languages are needed and thereupon translates the policy code into the relevant policy languages.

The example pipeline engine 206 is programmed to automate policy code deployment to various policy engines, such as the policy engines 208. The pipeline engine 206 is configured to accept the policy code that is translated by the translation engine 204 and distribute that policy code through a pipeline to the appropriate policy engines 208.

This distribution by the pipeline engine 206 can be semi- or fully-automated. For instance, the translation engine 204 can provide both the translated policy code and relevant engine to the pipeline engine 206 or the pipeline engine 206 can be programmed to recognize the relevant policy engine based upon the translated policy code. The pipeline engine 206 can thereupon validate and distribute that translated policy code to the proper policy engines 208. For instance, the pipeline engine 206 can provide testing of the policy code before distribution to the policy engines 208.

The example policy engines 208 are programmed to consume the translated code that is distributed by the pipeline engine 206 and implement those policies within the system 100. In this example, multiple policy engines 208 consume the relevant translated policy code to implement the policies. For instance, a policy engine A can consume the original policy code, while another policy engine B can consume the translated policy code. In this manner, the system 100 allows for distribution of policy code to multiple different policy engines without requiring manual changes or translation of the code.

The example logging engine 210 is programmed to log the various actions of the server device 112. In one instance, this can include logging the translations that are performed by the server device 112, with indications when such translations are successful or unsuccessful (e.g., due to errors). The logging engine 210 can be programmed to log this information to one or more log files that can be consumed by various other entities, such as the reporting engine 212.

The example reporting engine 212 is programmed to provide reports related to the system 100, including the performance of the server device 112. For instance, the reporting engine 212 can be programmed to generate a dashboard that provides various metrics for the system 100, such as the amount of translations that have been performed, the success rates, and what policy engines have consumed the translations. This dashboard can be used to determine the overall health and/or performance of the system 100 and identify problem areas for the server device 112 as policy definitions are delivered to various policy engines throughout the system 100.

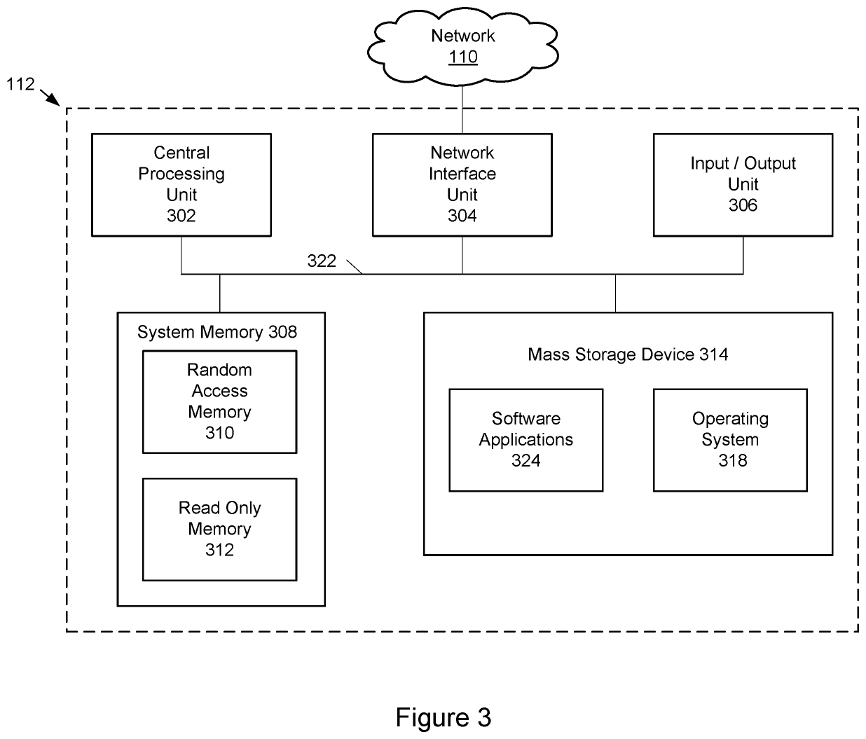

As illustrated in the embodiment of FIG. 3, the example server device 112, which provides the functionality described herein, can include at least one central processing unit (“CPU”) 302, a system memory 308, and a system bus 322 that couples the system memory 308 to the CPU 302. The system memory 308 includes a random-access memory (“RAM”) 310 and a read-only memory (“ROM”) 312. A basic input/output system containing the basic routines that help transfer information between elements within the server device 112, such as during startup, is stored in the ROM 312. The server device 112 further includes a mass storage device 314. The mass storage device 314 can store software instructions and data. A central processing unit, system memory, and mass storage device similar to that shown can also be included in the other computing devices disclosed herein.

The mass storage device 314 is connected to the CPU 302 through a mass storage controller (not shown) connected to the system bus 322. The mass storage device 314 and its associated computer-readable data storage media provide non-volatile, non-transitory storage for the server device 112. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server device 112.

According to various embodiments of the invention, the server device 112 may operate in a networked environment using logical connections to remote network devices through network 110, such as a wireless network, the Internet, or another type of network. The server device 112 may connect to network 110 through a network interface unit 304 connected to the system bus 322. It should be appreciated that the network interface unit 304 may also be utilized to connect to other types of networks and remote computing systems. The server device 112 also includes an input/output controller 306 for receiving and processing input from a number of other devices, including a touch user interface display screen or another type of input device. Similarly, the input/output controller 306 may provide output to a touch user interface display screen or other output devices.

As mentioned briefly above, the mass storage device 314 and the RAM 310 of the server device 112 can store software instructions and data. The software instructions include an operating system 318 suitable for controlling the operation of the server device 112. The mass storage device 314 and/or the RAM 310 also store software instructions and applications 324, that when executed by the CPU 302, cause the server device 112 to provide the functionality of the server device 112 discussed in this document.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A computer system for automating policy management, comprising:
one or more processors; and
non-transitory computer-readable storage media encoding instructions which, when executed by the one or more processors, causes the computer system to create:
a translation engine programmed to take policy code in a first format and translate the policy code to a second format; and
a pipeline engine programmed to automatically distribute the policy code in the first format to a first policy engine and distribute the policy code in the second format to a second policy engine.

2. The computer system of claim 1, wherein the first format is a first programming language, and wherein the second format is a second programming language different from the first programming language.

3. The computer system of claim 1, wherein the translation engine is further programmed to automatically translate the policy code based upon a type of the second policy engine.

4. The computer system of claim 1, wherein the translation engine is further programmed to automatically translate the policy code using one or more models.

5. The computer system of claim 4, comprising further instructions which, when executed by the one or more processors, causes the computer system to train the one or more models to perform translation.

6. The computer system of claim 4, comprising further instructions which, when executed by the one or more processors, causes the computer system to create a development engine programmed to accept the policy code in the first format and store the policy code in a database.

7. The computer system of claim 1, wherein the pipeline engine is programmed to apply the policy code across multiple policy engines by selecting a code format for each of the multiple policy engines.

8. The computer system of claim 1, wherein the pipeline engine is programmed to validate the policy code in the first format and the second format before distribution.

9. The computer system of claim 1, comprising further instructions which, when executed by the one or more processors, causes the computer system to create a logging engine programmed to log the policy management actions performed by the computer system.

10. The computer system of claim 1, comprising further instructions which, when executed by the one or more processors, causes the computer system to create a reporting engine programmed to generate a dashboard that provides various metrics for the computer system.

11. A method for automating policy management, comprising:
translating policy code in a first format to a second format; and
automatically distributing the policy code in the first format to a first policy engine and distribute the policy code in the second format to a second policy engine.

12. The method of claim 11, wherein the first format is a first programming language, and wherein the second format is a second programming language different from the first programming language.

13. The method of claim 11, further comprising automatically translating the policy code based upon a type of the second policy engine.

14. The method of claim 11, further comprising automatically translating the policy code using one or more models.

15. The method of claim 14, further comprising training the one or more models to perform translation.

16. The method of claim 14, further comprising accepting the policy code in the first format and store the policy code in a database.

17. The method of claim 11, further comprising applying the policy code across multiple policy engines by selecting a code format for each of the multiple policy engines.

18. The method of claim 11, further comprising validating the policy code in the first format and the second format before distribution.

19. The method of claim 11, further comprising logging policy management actions.

20. The method of claim 11, further comprising generating a dashboard that provides various metrics for the policy management.
